(19) United States
(12) Patent Application Publication
(10) Pub. No.: US 2004/0164861 A1
(43) Pub. Date: Aug. 26, 2004

(54) Antenna-mounted vehicle location system

(76) Inventor: Dennis G. Rawson, Sunnyvale, CA (US)

Correspondence Address: Johney U. Han, Morrison & Foerster LLP, 402 Novato Avenue, Sunnyvale, CA, 94086, US

(21) Appl. No.: 10/374,825

(22) Filed: Feb. 25, 2003

(51) Int. Cl. G08B 1/08

(52) U.S. Cl. 340/539.32; 340/425.5

(57) ABSTRACT

An antenna-mounted vehicle location system is described herein. The vehicle location system allows a user to remotely activate an illumination device attached to a vehicle antenna. The illumination device can be selectively activated by a user via a portable activator. This activator can be in the form of a key fob and is small enough for comfortably carrying within a pocket, purse, etc. The illumination device can be configured to receive an RF signal from the activator to cause the device to emit a signal light for alerting the user as to the vehicle's location.

### FIELD OF THE INVENTION

The present invention relates to vehicle location systems. More particularly, the present invention relates to antenna-mounted remotely activated vehicle locating devices.

### BACKGROUND OF THE INVENTION

With the ever increasing numbers of automobiles in urban areas, there is a high frequency for using large parking lots and garages. Many of these lots and garages are utilized at night or are dimly lit, e.g., covered or enclosed garages.

There have been previous attempts at providing ways for aiding in locating automobiles in crowded parking lots. Many of these lots or garages are marked with location signs to aid the driver in finding the location of their car upon return. Others have attached markers to their vehicles, such as a flag, in order to aid in the location of their vehicle. These other aids have met with limited success. In some circumstances, such as late in the evening, where there is insufficient light to view such aids, one's memory often fails to recall the location of the vehicle and the driver is left to wander about to find their automobile. This poses a considerable security concern to many people.

Accordingly, there remains a need to overcome these problems in the field of automobile locating devices. There remains a need for an improved vehicle locating device which overcomes these problems.

### BRIEF SUMMARY OF THE INVENTION

The present invention comprises a vehicle location system which may allow a user to remotely activate an illumination device preferably attached to the vehicle's antenna. The light-emitting apparatus may be affixed to the top of the antenna of the subject vehicle and it may be selectively activated by a user via a portable activator.

The activator may be configured as a key fob for holding items such as key(s) and it is preferably small enough for comfortably carrying within a pocket, purse, etc. of the user. An activation switch may be located on the activator and activated when depressed or actuated when the user is attempting to locate the vehicle. Such actuation may cause the activator to emit a signal, such as an RF signal, which may be intercepted by the apparatus. The receipt of the signal by an RF receiver, for instance, located on the apparatus may cause the device to emit a signal light for alerting the user as to the vehicle's location.

### BRIEF DESCRIPTION OF THE DRAWINGS

FIG. 1 shows one example of remotely activating a variation of the antenna-mounted illumination device.

FIGS. 2A and 2B show cross-sectional views of one variation of the interior of an antenna-mounted illumination device.

FIG. 3 shows a schematic illustration of one variation of a circuit which may be used for the illumination device.

FIGS. 4A and 4B show additional variations for the illumination device enclosure.

### DETAILED DESCRIPTION OF THE INVENTION

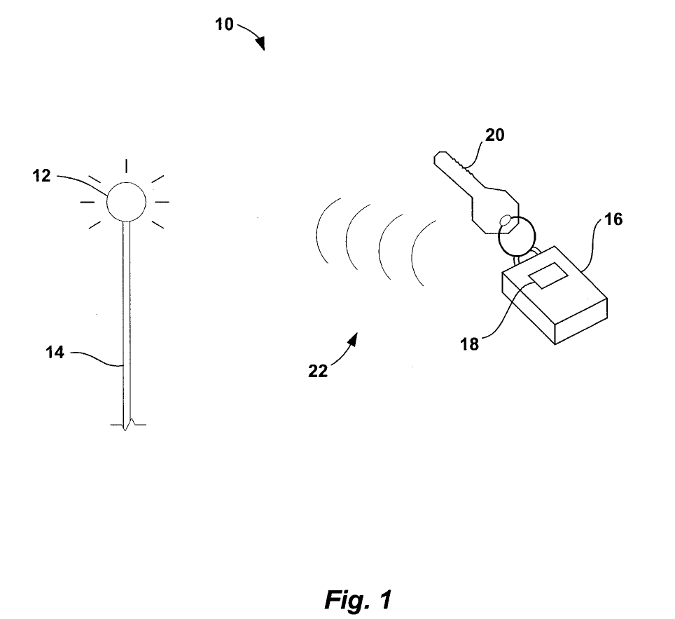

The vehicle location system described herein allows a user to remotely activate an illumination device which may be attached to the vehicle's antenna. FIG. 1 shows an example of one variation 10 of the invention in which light emitting apparatus 12 may be affixed to the top of antenna 14 of the subject vehicle. The user may carry portable activator 16 for selectively signaling light emitting apparatus 12. Activator 16 may be configured as a key fob for holding items such as key(s) 20 and is preferably configured to be small enough for comfortably carrying activator 16 within a pocket, purse, etc. of the user. An activation switch 18 located on activator 16 may be depressed or actuated when the user is attempting to locate the vehicle. Such actuation may cause activator 16 to emit a signal 22, such as an RF signal, which may be intercepted by apparatus 12 and which may signal activator 16 to emit a signal light for alerting the user as to the vehicle's location.

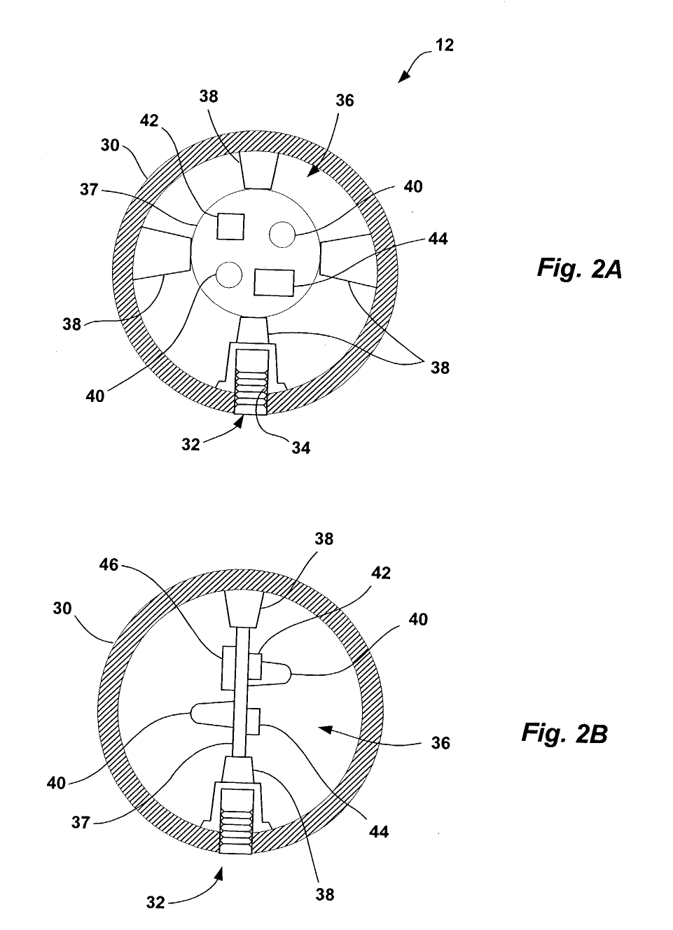

FIG. 2A shows a cross-sectional view of one variation of light emitting apparatus 12. As seen, apparatus 12 may comprise an enclosure 30, shown in this variation as a spherical body, which may be made of a variety of water-resistant materials such as plastics, polymers, rubbers, etc. Enclosure 30 is preferably made to be transparent or translucent such that a signal light emitted from within enclosure 30 may be transmitted through the walls of enclosure 30. Enclosure 30 may be configured to be opened, e.g., via a hinge or along a split, to allow access to its interior for maintenance or for replacing interior components, as described in further detail below. Alternatively, enclosure 30 may be made to be permanently sealed. In either case, the enclosure 30 is preferably configured such that it is water-resistant once it is closed or sealed during use.

Enclosure 30 may further define a positioning channel 32 extending at least partly into the body of the enclosure. Such a channel 32 may be configured to have, e.g., ridges 34, or any other raised feature. Alternatively, a spongy material may be used within channel 32 to enhance the gripping action of channel 32. Such a feature would allow for apparatus 12 to be positioned upon an antenna, such as one typically found on automobiles, via channel 32; and ridges 34 may allow apparatus 12 to maintain a tight fixture upon the antenna through frictional interference. Channel 32 would allow for fixation upon the antenna until the apparatus 12 is selectively removed by the user by applying a removal force upon apparatus 12.

Enclosed entirely within enclosure 30 is light emitting assembly 36. Assembly 36 may be fixedly positioned within enclosure 30 by one or several struts or supports 38 which may be positioned within enclosure 30 at one or several locations such that assembly 38 is securely maintained. Struts 38 may be separately manufactured and affixed within enclosure 30; alternatively, they may be integrally manufactured with enclosure 30 such that they are uniform in material and integral in construction with enclosure 30.

Assembly 36 may include single or multiple layers of, e.g., polyimide material, or it may simply comprise a non-conductive substrate material 37, such as plastic or polymer. A number of light emitting components 40, such as incandescent lights or light emitting diodes, may be positioned upon substrate 37 such that they provide for the emission of a signal light in a full 360° direction about apparatus 12. FIGS. 2A and 2B show two light emitting diodes (LEDs) mounted on substrate 37 in opposing directions such that light is emitted on both or either side of substrate 37. Although two LEDs are shown, they are merely intended to be illustrative and not limiting. Thus, any number of light emitting devices 40 may be utilized as practicable.

To supply power to the light emitting components 40, a power supply 42, e.g., a battery, may also be mounted upon substrate 37 in electrical communication with components 40. Power supply 42 may be a permanently mounted power supply, or it may be replaceable battery, or it may also be a self-generating power supply powered by the motion of the apparatus, or it may also be a solar-powered battery, i.e., a photovoltaic cell, depending upon whether enclosure 30 is configured to open or remain permanently sealed.

As shown in FIG. 2B, which is a side view of apparatus 12 from FIG. 2A, receiver 46 is also mounted upon substrate 37 in electrical communication with light emitting components 40, power supply 42, and an optional capacitor 44. Receiver 46 is preferably a wireless-type receiver configured to receive, e.g., RF signals, from activator 16. Once receiver 46 has received a signal, it can be configured to close an electrical switch to allow for current to flow from power supply 42 to power light emitting components 40 to signal to the user the location of apparatus 12 and the vehicle or object upon which it may be secured.

An optional capacitor 44 may also be provided and placed into electrical communication with power supply 42 such that current from power supply 42 may be stored and discharged to provide for a limited period of time which light emitting components 40 are ON. The apparatus 12 may also be configured such that when light emitting components 40 are in an ON state, they may be adapted to emit the light signal in a pulsed light pattern. Alternatively, components 40 may be adapted to emit light in a continuous lighted signal, or they may alternatively be adapted to emit the light signal as a decaying light. Any of these light emission patterns may be accomplished by any of the techniques as known by one of ordinary skill the art.

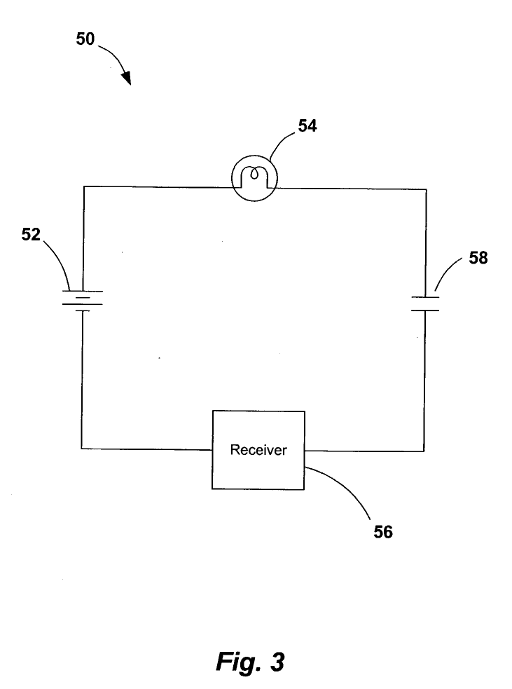

FIG. 3 shows one example of schematic 50 of an electrical circuit which may be utilized for apparatus 12. As shown, receiver 56 may be configured to close the circuit upon receiving a signal from an activator. Once the circuit is closed, power supply 52 can provide the current to light emitting components 54 to an ON state while an optional capacitor 58 may also be provided in the circuit as well.

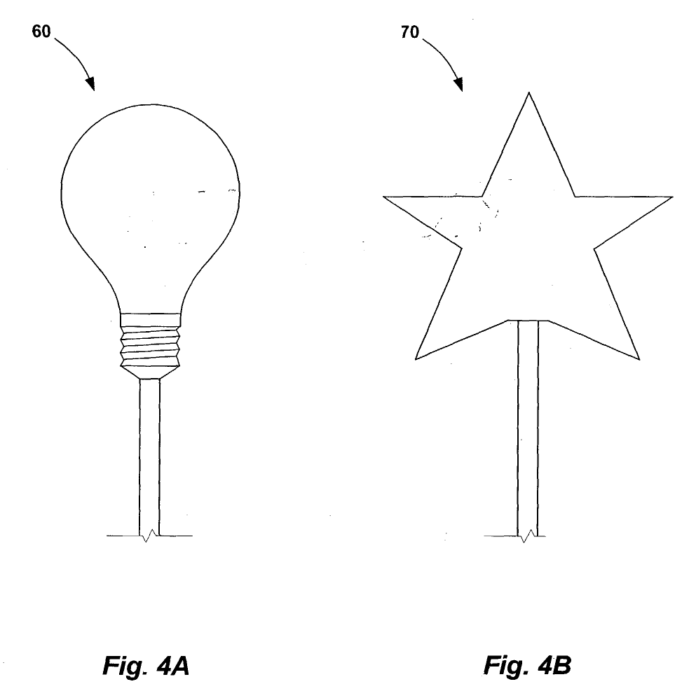

Although the apparatus 12 described above is shown in a spherical shape, any variety of enclosure embodiments may be utilized with the present invention to provide for an aesthetic appeal to the user. For instance, FIGS. 4A and 4B show additional examples for enclosure shapes. FIG. 4A shows enclosure 60 in the shape and configuration of a light bulb while FIG. 4B shows enclosure 70 in the shape and configuration of a star.

Accordingly, the present invention is not limited to the shape of the enclosure, rather any shape or design may be utilized. Nor is the present invention so limited in application for mounting to an antenna on a vehicle but it may also be mounted upon any object for which its location may be sought by use of the present invention.

I claim:

1. A self-contained antenna-mounted system for locating a vehicle, comprising:
a light emitting apparatus having at least one light source in electrical communication with a power supply and a receiver;
an enclosure adapted to contain the light emitting apparatus and power supply therewithin, wherein the enclosure is further adapted to be removably positioned upon an antenna affixed to the vehicle to be located; and
a portable activator adapted to be in wireless communication with the receiver such that actuating the activator causes the at least one light source to emit a signal.

2. The system of claim 1 wherein the light emitting apparatus further comprises a capacitor in electrical communication with the power supply and the receiver.

3. The system of claim 1 wherein the light source comprises an incandescent light.

4. The system of claim 1 wherein the light source comprises a light emitting diode.

5. The system of claim 1 wherein the light emitting apparatus comprises a plurality of light sources each in communication with the power supply.

6. The system of claim 1 wherein the power supply comprises a battery.

7. The system of claim 1 wherein the enclosure is adapted to be fluid-tight.

8. The system of claim 1 wherein the enclosure defines a spherical shape.

9. The system of claim 1 wherein the enclosure defines an antenna receiving channel adapted to receive the antenna such that the enclosure is tightly held onto the antenna.

10. The system of claim 1 wherein the activator comprises a handheld apparatus adapted to fit within a pocket of a user.

11. The system of claim 1 wherein the activator comprises an activation switch, wherein when the switch is depressed the light source is caused to emit the signal.

12. The system of claim 1 wherein the signal is a pulsed light signal.

13. The system of claim 1 wherein the signal is a continuous light signal.

14. The system of claim 1 wherein the signal is a decaying light signal.
